(19) United States
(12) Patent Application Publication
(10) Pub. No.: US 2006/0196763 A1
(43) Pub. Date: Sep. 7, 2006

(54) Method for manufacturing shell shaped fine carbon particles

(76) Inventors: Man Soo Choi, Seoul (KR); Sang Hoon Lee, Ansan-si (KR); Jun Young Hwang, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 10/638,131

(22) Filed: Aug. 8, 2003

Related U.S. Application Data
(63) Continuation-in-part of application No. PCT/KR02/00221, filed on Feb. 9, 2002.

(30) Foreign Application Priority Data
Feb. 10, 2001 (KR) 2001-6618

(51) Int. Cl. C01B 31/02; C01B 31/00

(52) U.S. Cl. 204/157.47; 423/445 R

(57) ABSTRACT

A method for producing shelled, fine carbon particles is provided. In the method, a hydrocarbon compound in the form of droplets being derived in a flame or during pyrolysis is irradiated with a laser beam to induce physical structural changes as well as chemical reactions in the precursor compound, so that shelled, fine carbon particles with a core-empty crystalline structure can be continuously formed.

### RELATED APPLICATIONS

This application is a continuation-in-part under 35 U.S.C. § 365 (c) claiming the benefit of the filing date of PCT Application No. PCT/KR02/00221 designating the United States, filed Feb. 9, 2002. The PCT Application was published in English as WO 02/066375 A1 on Aug. 29, 2002, and claims the benefit of the earlier filing date of Korean Patent Application No. 2001/6618, filed Feb. 10, 2001. The contents of the Korean Patent Application No. 2001/6618 and the international application No. PCT/KR02/00221 including the publication WO 02/066375 A1 are incorporated herein by reference in their entirety.

### BACKGROUND OF THE INVENTION

1. Field of the Invention

The present invention relates to the production of shelled carbon particles from soot of hydrocarbon flames or soot resulting from the pyrolysis of hydrocarbon, and more particularly, to a method for producing shelled carbon particles having a discrete structure and physical properties derived from common soot by changing particles' size, shape and crystalline structure through laser irradiation of soot precursors.

2. Description of the Related Art

Due to their structural feature, shelled, fine carbon particles exhibit outstanding electrical, optical, mechanical, and chemical properties and have been considered to be a promising future material free from the technically limiting constraints now present in a variety of application fields. Liquid crystal displays (LCDs) are based on the property of organic compounds in a liquid crystal state that gives electrical activity through systematical interaction with light. LCDs have many advantages such as small-size, light-weight, low power consumption, and non-emission of electromagnetic waves known to be harmful to the human body. That is why, they have been widely used in electronic calculators, notebook computers, desk-top computer monitors, and television receivers.

Some well-known techniques for fabricating shelled, fine carbon particles are the physical method, the chemical method, and the reprocessing method.

The physical method involves high-energy irradiation of carbonaceous base material, including graphite, with high-power laser or arc electrodes to produce shelled, fine carbon particles. However, such a physical method needs frequent supplements of base material due to rapid consumption and transformation of the base material during the process. Also, amorphous soot is prevalent in the resulting carbon particles with a low yield of shelled, fine carbon particles, less than 1%, including fullerene and carbon nanotubes.

The chemical method involves combustion of hydrocarbon materials in a gas or liquid state or pyrolysis of the same through a series of chemical reactions induced by heating, to produce shelled, fine carbon particles. Such a chemical method utilizes simpler apparatuses and techniques than the physical method, causes low energy consumption, and allows continuous production. As in the physical method, the chemical method produces a very small quantity of shelled carbon particles, relative to a by-product, soot, with a yield of 0.01% or less, which is lower than the amount obtained by the physical method.

The reprocessing method involves collecting the amorphous carbon particles including soot or carbon black, which are by-products from the physical or chemical method, and applying additional physical energy to the amorphous carbon particles, for example, by laser or electron beam radiation, heating, etc., to convert the amorphous carbon particles into shelled, fine carbon particles. This reprocessing method has a relatively high yield, but has a problem of processing discontinuity because it requires collecting the particles and an additional process of the soot following soot production. In addition, the collected amorphous carbon particles to be subjected to further processing are in a physically and chemically stable state, so that relatively high energy or extended processing time is required to change their structure. Therefore, a more practical method which provides high productivity and energy efficiency for producing shelled, fine carbon particles is strongly required.

### SUMMARY OF THE INVENTION

To improve the low practicality and productivity in conventional physical, chemical, and reprocessing methods, the present invention provides various features of producing a carbonized particles.

One aspect of the present invention provides a method for producing shelled, fine carbon particles. The method comprises: synthesizing a soot precursor from a hydrocarbon material in a flame or by pyrolysis, the soot precursor not containing a carbon nucleus; radiating a laser beam onto the soot precursor to promote carbonization of a surface of the soot precursor; and producing the shelled, fine carbon particles by forming a carbon layer on the surface of the soot precursor and spreading an internal material of the soot precursor out of the carbon layer resulting from the carbonation. In this method, the soot precursor formed is a polycyclic aromatic hydrocarbon in the form of droplets. The soot precursor is irradiated with the laser beam at a location in the flame or a furnace. The soot precursor is irradiated with a laser beam at a location outside the flame or a furnace.

Another aspect of the present invention provides a method of producing a carbonized material. The method comprises: providing a soot precursor comprising hydrocarbons; subjecting the soot precursor to a condition sufficient for carbonization of the soot precursor; and applying a laser beam onto the soot precursor while the soot precursor is subjected to the carbonization condition, thereby producing a carbonized material. In this method, the hydrocarbons are selected from the group consisting of aliphatic hydrocarbons, polycyclic aromatic hydrocarbons and a mixture of two or more of the foregoings. The aliphatic hydrocarbons comprise acetylene. The subjection of the soot precursor to a carbonization condition comprises placing the soot precursor in a flame.

In the above-described method, the laser beam is applied to the soot precursor while the soot precursor is in the flame. The laser beam is applied to the soot precursor as soon as the soot precursor leaves from the flame. The subjection of the soot precursor to a carbonization condition comprises placing the soot precursor in a furnace. The laser beam is applied to the soot precursor while the soot precursor is within in the furnace. The laser beam is applied to the soot precursor after the soot precursor leaves from the furnace. The application of the laser beam induces the carbonization to occur near an outer surface of the soot precursor. The carbonization forms a carbon layer on the outer surface of the soot precursor. Materials in an interior area of the soot precursor are substantially vaporized. The carbonization is carried out t a temperature from about 1,000K about 3,000K. The carbonization is carried out at a temperature above about 1000K.

Still in the above-described method of producing a carbonized material, the soot precursor, to which the laser beam is applied, is substantially free from carbon nuclei. The soot precursor, to which the laser beam is applied, includes one or more carbon nuclei. The soot precursor, to which the laser beam is applied, is in a state prior to when the soot precursor turns into a matured soot particle. The method further comprises collecting the carbonized material. The carbonized material has an outer carbon layer and a substantially hollow interior substantially enclosed or surrounded by the carbon layer. The carbonized material is fullerenes or carbon nanotubes. The laser beam is applied at a power from about 10³ to about 10⁵ W/cm². The laser beam is applied at a power in an order of 10⁴ W/cm².

A further aspect of the present invention provides a method of producing a carbonized material. The method comprises: providing a soot precursor comprising hydrocarbons; subjecting the soot precursor to heat sufficient for carbonization of the soot precursor; and causing the carbonization to occur substantially near an outer surface of the soot precursor. In the method, causing the outer surface carbonization comprises applying a laser beam onto the soot precursor subjected to the heat prior to formation of carbon nuclei within the soot precursor. Causing the outer surface carbonization comprises applying a laser beam onto the soot precursor subjected to the heat prior to substantial completion of the carbonization within the soot precursor. The subjection of the soot precursor to heat comprises placing the soot precursor in a flame or furnace or passing the soot precursor through a flame or furnace. The carbonized material is fullerenes or carbon nanotubes.

Still another aspect of the present invention provides a method of producing a carbonized material. The method comprises: providing a particulate composition comprising carbon atoms and non-carbon atoms, the particulate composition having an outer surface; removing non-carbon atoms from an area of the outer surface of the particulate composition, wherein the area becomes substantially free of non-carbon atoms; and removing a mass of carbon atoms and non-carbon atoms from an interior area of the particulate composition. In the method, the area of the outer surface forms a carbon layer. The carbon layer comprises at least some carbon atoms removed from the interior area. The removal of non-carbon atoms from the outer surface area comprises simultaneously applying heat and a laser beam to the particulate composition. The removal of the mass from the interior area comprises simultaneously applying heat and a laser beam to the particulate composition. The laser beam is applied at a power from about 10³ to about 10⁵ W/cm². The coagulated material heated to a temperature from about 1,000K to about 3,000K.

A still further aspect of the present invention provides carbonized materials produced by the above-described methods. The carbonized material comprises an outer layer of carbon atoms and a substantially hollow interior.

### BRIEF DESCRIPTION OF THE DRAWINGS

The above and other features and advantages of the present invention will become more apparent by describing in detail exemplary embodiments thereof with reference to the attached drawings in which:

FIG. 1 shows the shapes, in each stage, of carbon particles produced by pyrolysis;

FIG. 2 shows the process of producing carbon particles inside a flame;

FIG. 3 shows the process of producing carbon particles outside a flame;

FIG. 4 shows the process of producing carbon particles in a furnace;

FIG. 5 shows a method of producing shelled, fine carbon particles by laser irradiation of a soot precursor being produced in a flame according to the present invention;

FIG. 6 shows a method of producing shelled, fine carbon particles by laser irradiation of a soot precursor being produced outside a flame according to the present invention;

FIG. 7 shows a method of producing shelled, fine carbon particles in a furnace with a laser transmissive window according to an embodiment of the present invention;

FIG. 8 shows a method of producing shelled, fine carbon particles in a furnace without a laser transmissive window according to another embodiment of the present invention; and

FIG. 9 is a schematic diagram showing an example of the structure of a burner used in the present invention.

### DETAILED DESCRIPTION OF THE INVENTION

Hereinafter, the present invention will be described in greater detail with reference to the appended drawings.

To address the problems of the conventional physical, chemical, and reprocessing methods described above, the present invention is characterized in that during the production of carbon particles using a chemical method, a laser beam is radiated to concurrently cause chemical reactions and physical crystalline structure changes, so that high-purity, fine carbon particles can be continuously produced with the application of a minimum level of energy.

Methods to form soot precursors or soot particles include combustion techniques of reacting a hydrocarbon material with an oxidizing agent in discrete flames, pyrolysis techniques of heating a hydrocarbon material in a furnace, etc. When the temperature of the hydrocarbon material reaches above about 1000 K by combustion or heating, the hydrocarbon material undergoes pyrolysis through a series of chemical reactions. During the pyrolysis, amorphous, fine soot particles are formed as a final product.

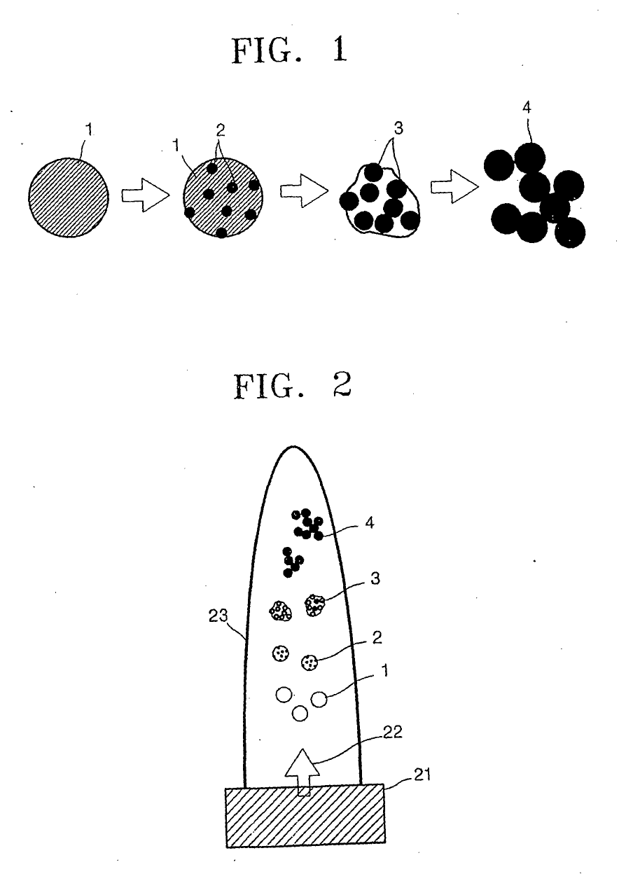

FIG. 1 shows the process of soot particle formation by pyrolysis, showing different shapes of soot particles and soot precursors in each stage. As shown in FIG. 1, a matured soot particle 4 is grown from a soot precursor 1 via a carbon nucleus 2 and an early-stage soot particle 3 by the pyrolysis of a hydrocarbon material and a series of chemical reaction and physical changes derived from the pyrolysis. The mechanism of the soot particle formation will be described step by step.

During the pyrolysis of hydrocarbon, polycyclic aromatic hydrocarbons (PAHs) having a chemically stable molecular structure with a five-member or six-member carbon ring are derived. PAH molecules react with neighboring hydrocarbons to grow into a larger molecular PAH. This growth of the PAH necessitates an increase in the carbon-to-hydrogen (C/H) ratio of the PAH.

Larger molecular weight of the PAH due to its growth raises the boiling point of the PAH molecule. When PAH molecules are grown to a molecular weight of about 1000-2000 amu or more, the PAH molecules are condensable even at a high temperature of about 1000 K. When sufficiently large PAH molecules are formed through rapid growth reactions during pyrolysis, the PHA molecules are condensed into PAH droplets to act as the soot precursor 1 in a flame or furnace.

The soot precursor 1 in the form of droplets is still highly reactive, so that it continues to grow through reaction with external hydrocarbon gas and forms intermolecular chemical bonds by a series of chemical reactions of the PAH droplets. This internal and external chemical reactions increase the number of carbon atoms in the PAH molecule and reduce the number of hydrogen atoms, thereby resulting in an increased carbon-to-hydrogen ratio, which is referred to as “carbonization”. During the carbonization, nucleation occurs on some droplet surfaces or in some droplets, thereby forming the carbon nucleus 2, which is completely carbonated.

After nucleation, the carbon nucleus 2 in the PAH droplet grows rapidly due to carbonization, and PAH droplets are consecutively converted into soot particles. In this stage, the carbon nucleus 2 develops into the early-stage soot particle 3 by consumption of the PAH droplets. When the PAH droplets are completely consumed, the resulting soot particle consists mostly of carbon. The fine carbon particle in this stage is referred to as the “matured soot particle 4”.

FIG. 2 shows the process of producing the soot precursor 1 through pyrolysis of a hydrocarbon material induced by combustion. As shown in FIG. 2, using a burner 21 having a single or a plurality of nozzles, a hydrocarbon material 22 and an oxidizing agent (not shown) are sprayed, separately or after being mixed together, to establish a flame 23. The hydrocarbon material 22 undergoes pyrolysis in the flame 23 and is then converted into soot particles following various stages. Alternatively, another fuel may be additionally supplied through the nozzle.

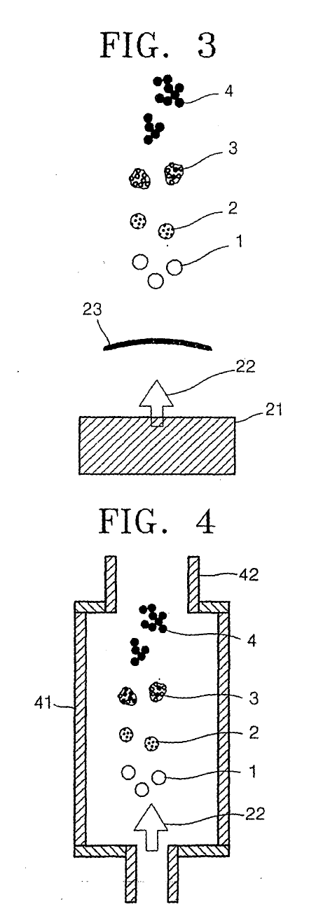

FIG. 3 shows the process of producing soot particles by pyrolysis of unburned hydrocarbon outside a flame. As shown in FIG. 3, the hydrocarbon 22 and the oxidizing agent, sprayed separately or after being mixed together, by the burner 21 form the flame 23, and unburned hydrocarbon is subjected to pyrolysis outside the flame, and then converted into soot particles 1, 2, 3, and 4 according to the various stages described above.

FIG. 4 shows the process of producing soot particles by directly heating a hydrocarbon material in a furnace. As shown in FIG. 4, hydrocarbon or a hydrocarbon-containing mixture 22 is supplied into a furnace 41 to form a stream towards an outlet 42 and converted into soot particles according to the various stages through pyrolysis.

Conventional reprocessing methods applied to form shelled carbon particles involve collecting matured soot particles produced by the chemical method described above and applying strong energy by a physical method, such as by radiating an electron or laser beam or by heating to induce physical structural changes in the matured soot particles so that carbon atoms in the matured soot particles are rearranged. Since such matured soot particles are chemically and physically stable, a huge amount of energy is required to change the physical structure of the matured soot particles. Furthermore, the additional application of energy after collecting matured soot particles interrupts continuous production.

The present invention has been designed to produce shelled, fine carbon particles in a continuous manner with the application of a minimum level of energy, by eliminating the above-described drawbacks of conventional methods.

In the present invention, instead of activating the physically and chemically stable matured soot particles like in the conventional methods, the soot precursor 1 in the form of PAH droplets before being developed into the carbon nucleus 2 is activated by laser irradiation to promote carbonization on the surface of the soot precursor 1 through a series of chemical reactions with external gas.

The soot precursor 1 contains a large amount of highly chemically reactive hydrogen, so it is more reactive than the matured soot particle mostly consisting of carbon. When the intensity of laser radiated is greater than a predetermined level, shelled carbon layers are formed on the particle surfaces due to spontaneous carbonization on the surfaces, even before visible physical/chemical changes such as nucleation occurs in the precursor soot particles. As the inside of the soot particle precursor is heated, the PAH droplets vaporize and spread out of the carbon layers. Then, the carbon layers harden while the chemical reaction is sustained, thereby resulting in shelled carbon particles.

The present invention is intended to promote the carbonization reaction, rather than to physically rearrange the crystalline structure of carbon particles. Therefore, shelled carbon particles can be produced with the method according to the present invention using an energy of about 10⁴ W/cm², approximately 1/1000 of the physical method, which needs an energy of about 10⁷-10⁸ W/cm². Therefore, shelled carbon particles can be produced in a continuous manner by radiation of a high-power, continuous wave (CW) of a laser toward an area where the soot precursor 1 is generated by pyrolysis in flames or a furnace.

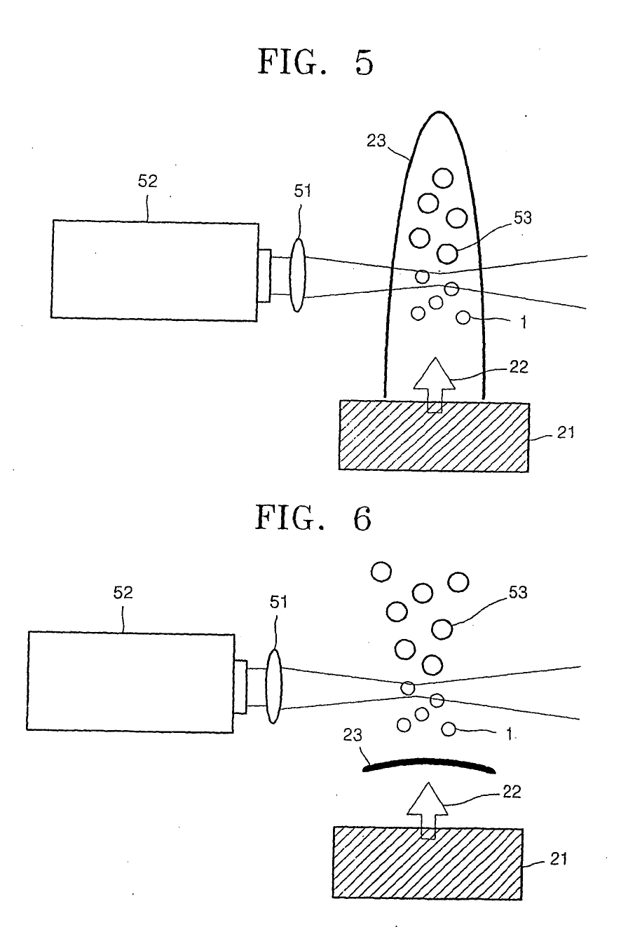

FIG. 5 shows an embodiment of a method of producing shelled, fine carbon particles by laser irradiation of the soot precursor 1 being produced in a flame according to the present invention. As shown in FIG. 5, a shelled, fine carbon particle 53 of 100 nm or less is produced by intensively radiating a laser beam from a laser source 52 through a spherical condensing lens 51 onto the soot precursor 1. In this method, the resulting carbon particle 53 is thermally and chemically stable, so that the carbon particle 53 can be collected outside the flame 23 without oxidation by the flame 23. Alternatively, the carbon particle 53 may be collected by inserting a collection device into the flame 23.

In another embodiment of the present invention, the laser radiation method described above may be applied to produce carbon particles from the soot precursor 1 being produced outside the flame, as shown in FIG. 6.

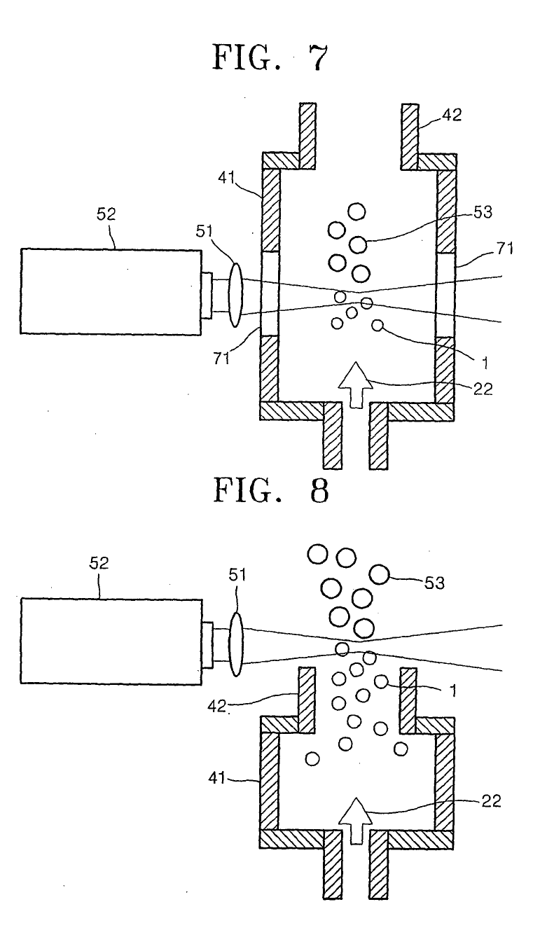

In still another embodiment of the present invention, the shelled, fine carbon particle 53 may be produced by radiation of a laser beam from the laser source 52 onto the soot precursor 1 being produced in a furnace 41, as shown in FIG. 7. In FIG. 7, the furnace 41 has a laser transmissive window 71 designed to radiate the laser beam from the laser source 52 toward an appropriate location.

FIG. 8 shows an alternative embodiment of the present invention in which the length of the furnace 41 is varied to produce the shelled, fine carbon particle 53 outside the furnace 41 by radiating a laser beam from the laser source 52 onto the soot precursor 1 exhausted through an outlet 42 of the furnace 41.

When using the furnace 41 as illustrated in FIGS. 7 and 8, the reaction efficiency can be improved by appropriately changing the flow rate and composition of the hydrocarbon material 33, the temperature and size of the furnace 41, the location of the outlet 42, etc.

The present invention will be described in greater detail with reference to the following embodiment. The following embodiment is for illustrative purposes and is not intended to limit the scope of the invention.

### Embodiment

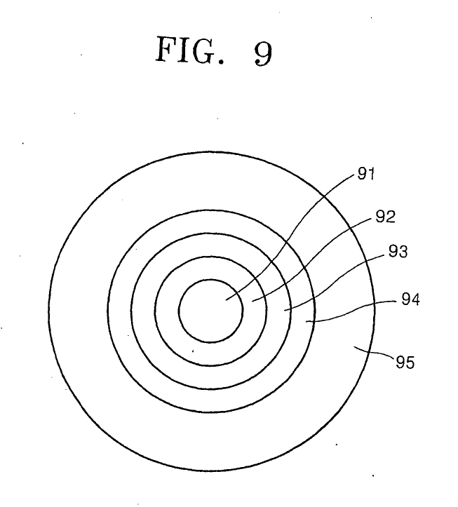

FIG. 9 is a schematic diagram showing an example of the structure of a burner 21 used in the present invention. Referring to FIG. 9, the burner 21 has five concentric nozzles. Hydrogen (fuel) is supplied through a fuel nozzle 93 at a flow rate of 1.0 lpm, and an oxidizing agent, a mixture of oxygen and nitrogen in a molar ratio of 1:1, is supplied through an oxidizing nozzle 94 at a flow rate of 1.0 μm, to establish a hydrogen/oxygen diffusion flame 23. While acetylene (C₂H₂), as the hydrocarbon material 22, is supplied through a center nozzle 91, having a diameter of 2 mm, at a flow rate of 0.1 lpm or a mass flow rate of 7.0 g/hr, the soot precursor 1 is formed through interaction with the hydrogen/oxygen diffusion flame 23. To appropriately adjust the position of production of the soot precursor 1, nitrogen gas as a barrier gas is flowed between the hydrogen/oxygen diffusion flame 23 and the hydrocarbon material 22 through a barrier gas nozzle 92 at a flow rate of 0.35 μm. To stabilize the hydrogen/oxygen diffusion flame 23, air is supplied through an outermost nozzle 95 at a flow rate of 50 lpm.

In this embodiment, the hydrogen/oxygen diffusion flame 23 has a length of about 50 mm, and the soot precursor 1 is produced at about 10 mm above the top outlet of the burner 21. As a CO₂-laser beam of about 2.2×10⁴ W/cm² is emitted from the laser source 52, to a position 10 mm above the top outlet of the burner 21, as shown in FIG. 5, the soot precursor 1 irradiated by the laser beam, is then converted into high-purity, shelled carbon particles 53 having an outer diameter of about 50 nm and a shell thickness of about 7 nm. More than 90% of the soot particles irradiated by the laser beam is converted into the shelled carbon particles 53 in the flame before moving a distance of 2 mm upward within about 0.2 ms. In the embodiment, the shelled carbon particles 53 are produced at a rate of about 0.4-0.7 g/hr on a mass basis with an yield of about 5-10% from the hydrocarbon material 22 supplied through the burner 21. More than 90% of the carbon particles generated in the flame within a distance of 5 mm from the laser radiation point are shelled carbon particles 53. The produced shelled carbon particles 53 are carried downstream without additional physical or chemical changes, and the unburned hydrocarbon material grows into new soot particles through a series of pyrolysis steps. The shelled carbon particles 53 are collected at a location within 5 mm from the laser radiation point with a yield of 90% or more. The yield decreases, as the distance of the collecting point from the laser radiation point increases, to about 50% at flame downstream.

As described above, based on the advantages of conventional physical, chemical, and reprocessing methods, a method for producing shelled, fine carbon particles by laser irradiation of a soot precursor according to the present invention eliminates the limitations of those methods, such as non-continuity of the process, low yield, and low energy efficiency, and improves substantially the productivity and yield of the particles due to the synergies gained from the combination of the conventional methods.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method for producing a shelled carbonized material, the method comprising:
synthesizing a soot precursor from a hydrocarbon material in a flame or by pyrolysis, the soot precursor not containing carbon particles;
radiating a laser beam onto the soot precursor to promote carbonization of a surface of the soot precursor; and
producing a shelled carbonized material by forming a carbon layer on the surface of the soot precursor and removing an internal material of the soot precursor out of the carbon layer resulting from the carbonization.

2. The method of claim 1, wherein the soot precursor formed is a polycyclic aromatic hydrocarbon in the form of droplets.

3. The method of claim 1, wherein the soot precursor formed is a carbon molecular cluster.

4. The method of claim 1, wherein, the soot precursor is irradiated with the laser beam at a location in the flame or a furnace.

5. The method of claim 1, wherein, the soot precursor is irradiated with a laser beam at a location outside the flame or a furnace.

6. A method of producing a carbonized material, comprising:
providing a soot precursor comprising hydrocarbons;
subjecting the soot precursor to a condition sufficient for carbonization of the soot precursor; and
applying a laser beam onto the soot precursor while the soot precursor is subjected to the carbonization condition, thereby producing a carbonized material.

7. The method of claim 6, wherein the hydrocarbons are one or more selected from the group consisting of gaseous hydrocarbons and polycyclic aromatic hydrocarbons.

8. The method of claim 6, wherein the subjection of the soot precursor to a carbonization condition comprises placing the soot precursor in a flame.

9. The method of claim 8, wherein the laser beam is applied to the soot precursor while the soot precursor is in the flame.

10. The method of claim 6, wherein the subjection of the soot precursor to a carbonization condition comprises placing the soot precursor in a furnace.

11. The method of claim 10, wherein the laser beam is applied to the soot precursor while the soot precursor is within in the furnace.

12. The method of claim 10, wherein the laser beam is applied to the soot precursor after the soot precursor leaves from the furnace.

13. The method of claim 6, wherein the application of the laser beam induces the carbonization to occur near an outer surface of the soot precursor.

14. The method of claim 13, wherein the carbonization forms a carbon layer on the outer surface of the soot precursor.

15. The method of claim 13, wherein materials in an interior area of the soot precursor are substantially vaporized.

16. The method of claim 6, wherein the carbonization is carried out at a temperature from about 1000K to about 3000K.

17. The method of claim 6, wherein the carbonization is carried out at a temperature above about 1000K.

18. The method of claim 6, wherein the soot precursor to which the laser beam is applied is substantially free from carbon particles.

19. The method of claim 6, wherein the soot precursor to which the laser beam is applied is in a state prior to when the soot precursor turns into a matured soot particle.

20. The method of claim 6, wherein the carbonized material comprises:
an outer carbon layer; and
a substantially hollow interior substantially enclosed or surrounded by the carbon layer.

21. The method of claim 6, wherein the carbonized material comprises fullerenes or carbon nanotubes.

22. The method of claim 6, wherein the laser beam is continuous.

23. A carbonized material produced by the method of claim 6.
